(19) United States
(12) Patent Application Publication
(10) Pub. No.: US 2026/0244231 A1
(43) Pub. Date: Aug. 20, 2026

(54) INTEGRATED CIRCUIT

(71) Applicant: FUJI ELECTRIC CO., LTD., Kawasaki-shi (JP)

(72) Inventor: Yuichi ITO, Matsumoto-city (JP)

(73) Assignee: FUJI ELECTRIC CO., LTD., Kawasaki-shi (JP)

(21) Appl. No.: 19/432,805

(22) Filed: Dec. 24, 2025

(30) Foreign Application Priority Data
Feb. 20, 2025 (JP) 2025-025737

(51) Int. Cl. G05F 1/567

(52) U.S. Cl. CPC G05F 1/567

(57) ABSTRACT

An integrated circuit, including: a bias current circuit including a first resistor, the bias current circuit being configured to generate a first bias current, based on the first resistor and a reference voltage; a second resistor to which the first bias current is supplied; n diodes to which a second bias current is supplied, the n diodes being connected in series, the serially-connected diodes having a first node on a power supply side thereof and a second node on a ground side thereof; and a compensation circuit configured to apply a compensation voltage corresponding to a voltage generated at the second resistor, to the second node. The n is an integer equal to one or more. A temperature coefficient of the second resistor and a temperature coefficient of the first resistor are either one of positive or negative.

### CROSS-REFERENCE TO RELATED APPLICATIONS

The present application claims priority pursuant to 35 U.S.C. § 119 from Japanese patent application number 2025-025737 filed on Feb. 20, 2025, the entire disclosure of which is hereby incorporated by reference herein.

### BACKGROUND

### Technical Field

The present disclosure relates to an integrated circuit.

### Description of the Related Art

Integrated circuits include those including a temperature sensor such as a diode or the like, to thereby being able to detect temperature (see, Japanese Patent Application Publication Nos. 2020-134512, 2024-34892, and 2006-324652, for example).

The temperature sensor of such an integrated circuit is affected by heat generated by the integrated circuit, and thus, in general, it is unable to accurately measure the temperature of the environment in which the integrated circuit is placed.

### SUMMARY

An aspect of the present disclosure is an integrated circuit, comprising: a bias current circuit including a first resistor, the bias current circuit being configured to generate a first bias current, based on the first resistor and a reference voltage; a second resistor to which the first bias current is supplied; n diode to which a second bias current is supplied, the n diode being connected in series; and a compensation circuit configured to apply a compensation voltage corresponding to a voltage generated at the second resistor, to a node on a ground side of the n diode, the n being an integer equal to one or more, a temperature coefficient of the second resistor being either one of positive or negative, a temperature coefficient of the first resistor being the either one.

Another aspect of the present disclosure is an integrated circuit, comprising: a bias current circuit including a first resistor, the bias current circuit being configured to generate a bias current, based on the first resistor and a reference voltage; n diode to which the bias current is supplied, the n diode being connected in series; and a second resistor connected in series with the n diode, the n being an integer equal to one or more, a temperature coefficient of the second resistor being either one of positive or negative, a temperature coefficient of the first resistor being the either one.

### BRIEF DESCRIPTION OF THE DRAWINGS

FIG. 1 is a diagram illustrating an example of an integrated circuit 10a.

FIG. 2 is a diagram illustrating an example of a bias current circuit 26.

FIG. 3 is a diagram illustrating an example of a temperature detection circuit 21a.

FIG. 4 is a diagram to describe the temperature detected by a temperature sensor.

FIG. 5 is a diagram illustrating an example of an integrated circuit 10b.

FIG. 6 is a diagram illustrating an example of a temperature detection circuit 21b.

### DETAILED DESCRIPTION

At least following matters will become apparent from the descriptions of the present description and the accompanying drawings. Herein, the same or equivalent constituent elements, members, and the like illustrated in the drawings are given the same reference numerals, and repetitive description is omitted as appropriate.

### Integrated Circuit 10a

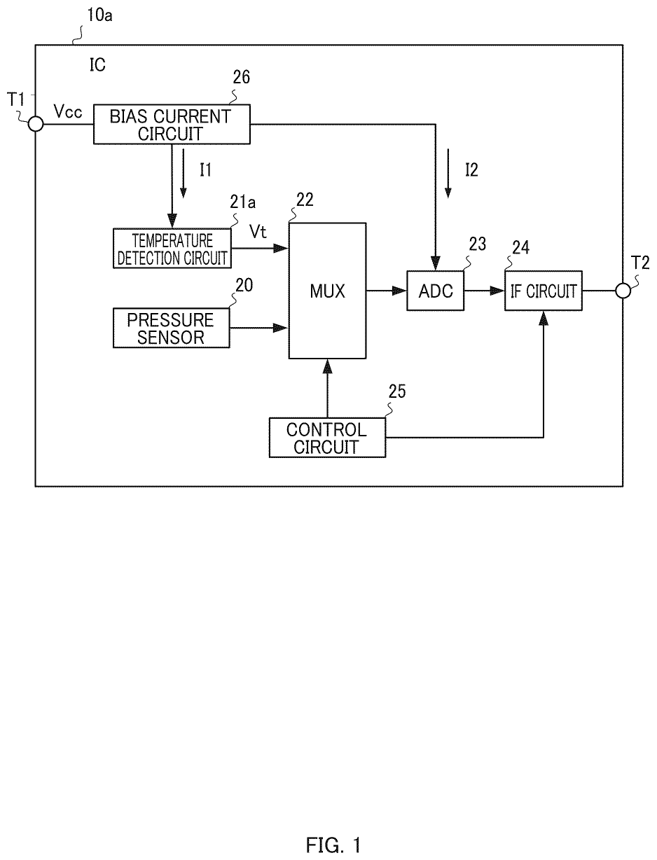

FIG. 1 is a diagram to describe an example of an integrated circuit 10a according to an embodiment of the present disclosure.

The integrated circuit 10a is a circuit capable of detecting pressure and temperature. The integrated circuit 10a includes a pressure sensor 20, a temperature detection circuit 21a, a multiplexer (MUX) 22, an analog-to-digital converter (hereinafter, referred to as ADC) 23, an interface circuit (hereinafter, referred to as IF circuit) 24, a control circuit 25, a bias current circuit 26, and terminals T1, T2.

The terminal T1 is a terminal to receive a power supply voltage Vcc to operate the integrated circuit 10a. Note that the power supply voltage Vcc is generated by a power supply circuit (not illustrated) external to the integrated circuit 10a.

The terminal T2 is a terminal through which information is exchanged between the integrated circuit 10a and an external device (for example, Electronic Control Unit (ECU)). Although details will be described later, the measured temperature and pressure are outputted from the terminal T2, for example, in an embodiment of the present disclosure.

The pressure sensor 20 is a sensor that outputs a voltage corresponding to pressure. The pressure sensor 20 is, for example, a piezoresistor bridge circuit (not illustrated) formed on a silicon diaphragm, and the output of the pressure sensor 20 is outputted to a multiplexer 22. It is assumed, in an embodiment of the present disclosure, that the integrated circuit 10a includes the pressure sensor 20, but the present disclosure is not limited thereto. For example, the pressure sensor 20 may be constituted by a chip separate from the integrated circuit 10a, and only the output from the pressure sensor 20 may be outputted to the multiplexer 22.

The temperature detection circuit 21a is a circuit that detects the temperature of the environment in which the integrated circuit 10a is placed (hereinafter, referred to as “environmental temperature Ta”). Note that the environmental temperature Ta in an embodiment of the present disclosure is, for example, the temperature of the medium of the pressure sensor 20. The temperature detection circuit 21a will be described in detail below.

The multiplexer 22 selects either the output of the pressure sensor 20 or the output of the temperature detection circuit 21a, in response to an instruction from the control circuit 25 (described below), for example, to thereby output a resultant to the ADC 23.

The ADC 23 is a circuit that converts the analog signal (here, an analog voltage) outputted from the multiplexer 22 into a digital signal. Note that the ADC 23 in an embodiment of the present disclosure converts the analog signal into a 12-bit digital signal, for example.

The IF circuit 24 is a circuit that exchanges various data between the internal circuitry of the integrated circuit 10a and an external device (for example, Electronic Control Unit (ECU)). In specific, the IF circuit 24 transmits the digital signal from the ADC 23 to the external device. Further, the IF circuit 24 also transmits an instruction from the external device to the control circuit 25.

The control circuit 25 is a circuit that integrally control the operation of the integrated circuit 10a. The control circuit 25 controls the multiplexer 22 and the IF circuit 24 by executing a program stored in a storage circuit (not illustrated), for example.

The bias current circuit 26 generates bias currents I1, I2 to operate the temperature detection circuit 21a and the ADC 23, respectively. It is assumed, in FIG. 1, that the bias current circuit 26 generates the bias currents I1, I2, but it may also generate bias currents with respect to other circuits (for example, the multiplexer 22, the IF circuit 24, and the control circuit 25).

### Bias Current Circuit 26

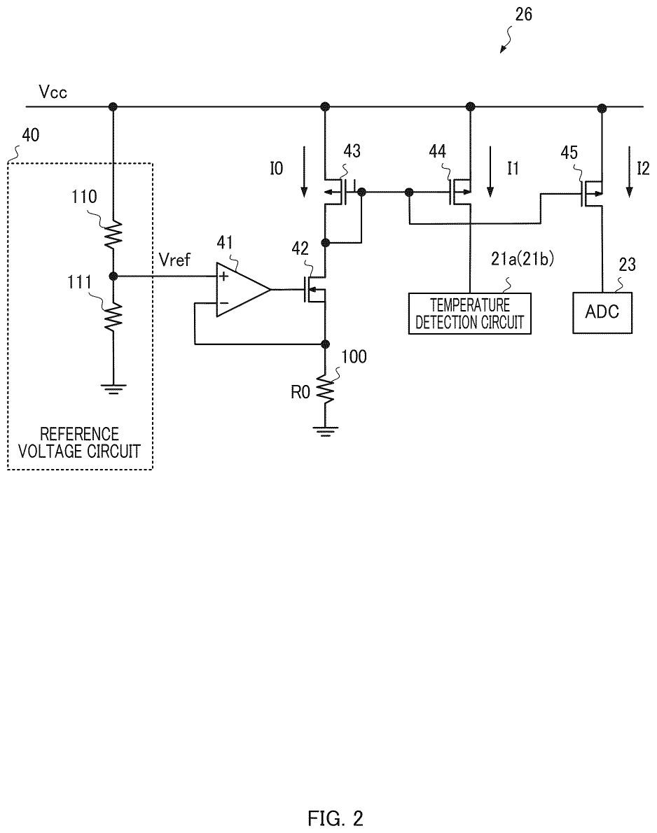

FIG. 2 is a diagram illustrating an example of the bias current circuit 26. The bias current circuit 26 is a circuit that generates the bias currents I1, I2 according to a reference voltage Vref and a resistor 100. The bias current circuit 26 includes a reference voltage circuit 40, an operational amplifier 41, an N-channel metal-oxide-semiconductor (NMOS) transistor 42, a P-channel metal-oxide-semiconductor (PMOS) transistors 43 to 45, and the resistor 100.

The reference voltage circuit 40 is a circuit that generates the reference voltage Vref corresponding to the power supply voltage Vcc, and includes resistors 110, 111. The reference voltage circuit 40 of an embodiment of the present disclosure divides the power supply voltage Vcc using resistors 110 and 111 that are connected in series, to thereby output the divided voltage as the reference voltage Vref. The reference voltage circuit 40 divides the power supply voltage Vcc with two resistors 110 and 111, but the present disclosure is not limited thereto, and the voltage may be divided with three or more resistors.

In an embodiment of the present disclosure, both the resistors 110 and 111 are polysilicon resistors. That is, in the integrated circuit 10a, when the resistors 110, 111 are manufactured, the material of the resistor 110 is the same as the material of the resistor 111. Accordingly, the respective temperature characteristics of the resistors 110 and 111 are also the same. As a result, the reference voltage Vref results in a temperature compensated voltage, although it depends on the power supply voltage Vcc.

It is assumed that the reference voltage circuit 40 of an embodiment of the present disclosure generates the reference voltage Vref corresponding to the power supply voltage Vcc, but the present disclosure is not limited thereto. For example, the band gap reference voltage circuit may be used as the reference voltage circuit 40, and a voltage at a predetermined level independent of temperature and the power supply voltage Vcc may be outputted as the reference voltage Vref.

The operational amplifier 41 has a non-inverting input terminal to receive the reference voltage Vref, and an inverting input terminal connected to the resistor 100. Further, the output of the operational amplifier 41 is connected to the gate electrode of the NMOS transistor 42. Accordingly, the operational amplifier 41 of an embodiment of the present disclosure controls the NMOS transistor 42 such that the voltage applied to the resistor 100 reaches the reference voltage Vref.

Here, a reference current I0 flowing through the resistor 100 is given by the following Expression (1):

I0=Vref/R0 (1),

where R0 is the resistance value of the resistor 100.

The diode-connected PMOS transistor 43 is connected to the drain electrode of the NMOS transistor 42. The power supply voltage Vcc is applied to the source electrode of the PMOS transistor 43. Thus, a voltage corresponding to the reference current I0 is generated at the gate electrode of the PMOS transistor 43.

The gate electrode of the PMOS transistor 43 is connected to the respective gate electrodes of the PMOS transistors 44, 45. Thus, the PMOS transistor 43 and the PMOS transistors 44, 45 configure a current mirror circuit. Accordingly, the bias currents I1, I2 corresponding to the reference current I0 flow through the PMOS transistors 44, 45, respectively.

In an embodiment of the present disclosure, the bias current I1 from the PMOS transistor 44 is supplied to the temperature detection circuit 21a, and the bias current I2 from the PMOS transistor 45 is supplied to the ADC 23. The resistor 100 corresponds to a “first resistor”, and the bias current I1 corresponds to a “first bias current” or a “bias current based on the first resistor and a reference voltage”.

### Remperature Detection Circuit 21a

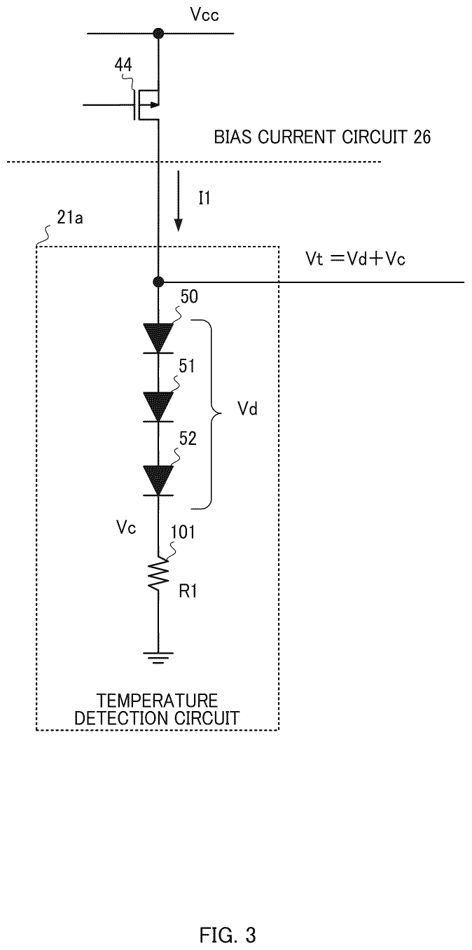

FIG. 3 is a diagram illustrating an example of the temperature detection circuit 21a. The temperature detection circuit 21a is a circuit that outputs a voltage Vt indicating the detected temperature (here, the environmental temperature Ta) to the multiplexer 22. The temperature detection circuit 21a includes three diodes 50 to 52 and a resistor 101.

The diodes 50 to 52 are connected in series between the PMOS transistor 44 of the bias current circuit 26 and the resistor 101 (described below). A forward voltage Vf of each of the diodes 50 to 52 has a predetermined temperature characteristic (for example, −2 mV/° C.). Thus, in an embodiment of the present disclosure, it is possible to detect the temperature, based on the temperature characteristic of the forward voltage Vf, which is proportional to the number of three.

The number of diodes included in the temperature detection circuit 21a is not limited to three, but may be at least one. However, with the use of multiple diodes, as in an embodiment of the present disclosure, it is possible to improve detection sensitivity of temperature. Further, in an embodiment of the present disclosure, the voltage generated between the anode of the diode 50 arranged closest to a power supply and the cathode of the diode 52 arranged closest to the ground is defined as a “voltage Vd”. Further, three corresponds to “n”, and 3 corresponds to “an integer equal to one of more”.

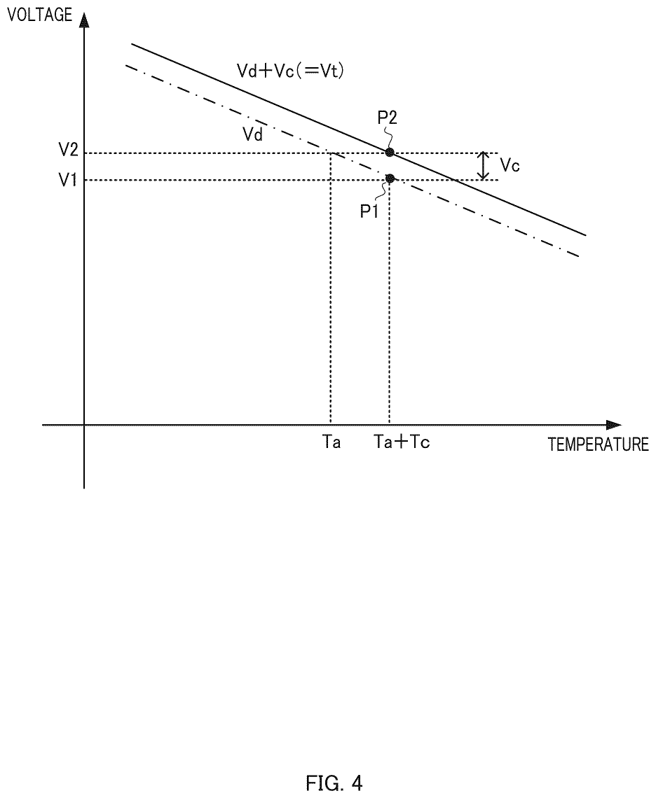

Here, the respective temperatures detected by the diodes 50 to 52 and the temperature detection circuit 21a will be described, with reference to FIG. 4. The dashed-dotted line in FIG. 4 is a diagram illustrating an example of the voltage Vd outputted by three diodes 50 to 52 to which the bias current I1 is supplied. In the dashed-dotted line in FIG. 4, three diodes 50 to 52 are used as a temperature sensor.

The diodes 50 to 52 in an embodiment of the present disclosure are formed in the integrated circuit 10a. Thus, the temperature detected by the diodes 50 to 52 is affected not only by the environmental temperature but also by the temperature of the integrated circuit 10a (hereinafter, referred to as “chip temperature Tc”).

Here, assuming that the temperature detected by the diodes 50 to 52 is the sum of the environmental temperature Ta and the chip temperature Tc, then, for example, the voltage Vd reaches the voltage V1 at a point P1 in FIG. 4. On the other hand, the voltage Vd when the diodes 50 to 52 detect only the environmental temperature Ta reaches a voltage V2 at a point P2 in FIG. 4. Accordingly, the difference voltage between the voltage V2 and the voltage V1 (hereinafter referred to as “voltage Vc”) corresponds to the chip temperature Tc.

Thus, if the voltage Vc corresponding to the chip temperature Tc can be added to the voltage Vd, the temperature detection circuit 21a can detect the environmental temperature Ta. The temperature detection circuit 21a in FIG. 3 is a circuit capable of adding the voltage Vc to the voltage Vd at the diodes 50 to 52. The temperature detection circuit 21a includes the resistor 101 to add the voltage Vc.

The resistor 101 applies the voltage Vc, which is given by the following Expression (2), to the cathode of the diode 52, in response to the bias current I1 being supplied thereto:

Vc=I1×R1 (2),

where I1 is the current value of the bias current I1, and R1 is the resistance value of the resistor 101.

Note that the resistance value R1 is determined based on the standard chip temperature Tc of the integrated circuit 10a, for example.

As described above, the bias current I1 of an embodiment of the present disclosure varies with the reference current I0. Then, the reference current I0 results in I0=Vref/R0, which has been derived from the above Expression (1). Further, the reference voltage Vref of an embodiment of the present disclosure is proportional to the power supply voltage Vcc. Accordingly, the voltage Vc of Expression (2) is given by the following Expression (3).

Vc∝(R1/R0)×Vcc (3)

### Temperature Coefficient

Here, if the voltage Vc has a temperature coefficient, the temperature coefficient of the voltage Vt indicating the temperature detected by the temperature detection circuit 21a will be affected not only by the temperature coefficient of the voltage Vd but also by the temperature coefficient of the voltage Vc. In such a case, the temperature coefficient of the voltage Vt will significantly deviate from the known temperature coefficient of the voltage Vd (for example, (−2 mV/° C.)×3).

Thus, in an embodiment of the present disclosure, preferably, the temperature coefficient of the voltage Vc reaches substantially zero (that is, it is temperature compensated). In Expression (3), the power supply voltage Vcc is generally generated by an external power supply circuit (not illustrated), and does not have temperature dependence. Thus, if the temperature coefficient of the resistor 100 and the temperature coefficient of the resistor 101 are substantially the same, the voltage Vc can be temperature compensated.

In an embodiment of the present disclosure, the resistor 100 of the bias current circuit 26 and the resistor 101 of the temperature detection circuit 21a are both polycrystalline silicon resistors formed at the silicon substrate (not illustrated) of the integrated circuit 10a. As such, when the material of the resistor 100 is the same as the material of the resistor 101, the respective temperature characteristics of the resistors 100 and 101 can be made substantially equal, thereby being able to cause the temperature coefficient of the voltage Vc to be substantially zero.

Thus, the temperature detection circuit 21a can make the temperature coefficient of the voltage Vt substantially equal to the temperature coefficient of the voltage Vd. Further, in an embodiment of the present disclosure, the resistance value R1 of the resistor 101 is set such that the magnitude of the voltage Vc indicates the standard chip temperature Tc. Accordingly, the voltage Vt (=Vd+Vc) indicative of the environmental temperature Ta is outputted from the temperature detection circuit 21a. Therefore, by measuring the voltage Vt, the environmental temperature Ta can be obtained with high accuracy. Note that the resistor 101 corresponds to a “second resistor”.

When the resistors 100, 101 are polysilicon resistors, respectively, for example, the respective temperature coefficients of the resistors 100, 101 are negative. Further, the phrase “the material of the resistor 100 is the same as the material of resistor 101” means that the material (e.g., arsenic (As), phosphorus (P), boron (B)) used to manufacture the polysilicon resistor corresponding to the resistor 100 is the same as the material used to manufacture the polysilicon resistor of the resistor 101. As long as the respective materials of the resistors 100, 101 are the same, the respective dopant concentrations of the materials thereof may be different.

It is assumed here that the resistors 100, 101 are polysilicon resistors with temperature coefficients being negative, but the present disclosure is not limited thereto. For example, each of the resistors 100, 101 may be an offset resistor with a temperature coefficient being positive. Further, the respective temperature coefficients of the resistors 100, 101 are preferably equal, but the temperature coefficients of the resistors 100, 101 only have to have at least the same sign (be positive or negative). That is, the resistors 100, 101 does not necessarily use the same material.

### Manufacturing Variations

The resistance value R0 of the resistor 100 in the bias current circuit 26 is an element manufactured at the silicon substrate (not illustrated), and thus the resistance value R0 varies. For example, in response to the resistance value R0 increasing from the standard value, the reference current I0 decreases. As a result, the power consumption of the integrated circuit 10a decreases, and the chip temperature Tc drops. On the other hand, for example, in response to the resistance value R0 decreasing from the standard value, the reference current I0 increases. As a result, the power consumption of the integrated circuit 10a increases, and the chip temperature Tc rises.

Accordingly, it is preferable that with an increase in the reference current I0 and a rise in the chip temperature Tc, the voltage Vc also rises, and with a reduction in the reference current I0 and a drop in the chip temperature Tc, the voltage Vc drops.

In an embodiment of the present disclosure, the resistors 100, 101 are manufactured such that the variations in the resistance value R1 of the resistor 101 will be sufficiently smaller than the variations in the resistance value R0 of the resistor 100. Accordingly, even if the resistance value R0 significantly varies from the standard value, the resistance value R1 remains substantially at the standard value. Thus, even if the same material is used for the resistors 100, 101, the voltage Vc that rises with an increase in the reference current I0 and drops with a reduction in the reference current I0 is obtained.

This enables the temperature detection circuit 21a not only to output the voltage Vt (=Vd+Vc) indicating the environmental temperature Ta, but also to vary the magnitude of the voltage Vt according to the magnitude of the reference current I0. That is, even if the chip temperature Tc varies due to the influence of the reference current I0, the temperature detection circuit 21a can output the voltage Vt in which the influence of the chip temperature Tc has been suppressed. Accordingly, in such a case, by measuring the voltage Vt, it is possible to determine the environmental temperature Ta with high accuracy.

When both resistors 100, 101 are polysilicon resistors, the sheet resistance of the resistor 101 simply have to be set sufficiently smaller than the sheet resistance of the resistor 100 in order to make the variations in the resistance value R1 smaller than the variations in the resistance value R0. This makes it possible to prevent the resistance value R1 from significantly varying, even if the dopant concentration of the material of the polysilicon resistor of the resistor 101 varies.

### Dependence of Power Supply Voltage Vcc

In response to the power supply voltage Vcc applied to the integrated circuit 10a rising and the power consumption of the integrated circuit 10a increasing, the chip temperature Tc rises. In specific, as illustrated in the above Expression (3), the voltage Vc in an embodiment of the present disclosure is proportional to the power supply voltage Vcc.

This enables the temperature detection circuit 21a not only to output the voltage Vt (=Vd+Vc) indicating the environmental temperature Ta, but also to change the magnitude of the voltage Vt, according to the magnitude of the power supply voltage Vcc. That is, even if the chip temperature Tc changes due to the influence of the power supply voltage Vcc, the temperature detection circuit 21a can output the voltage Vt in which the influence of the power supply voltage Vcc has been suppressed. Accordingly, in such a case, by measuring the voltage Vt, the environmental temperature Ta can be obtained with high accuracy.

### Integrated Circuit 10b

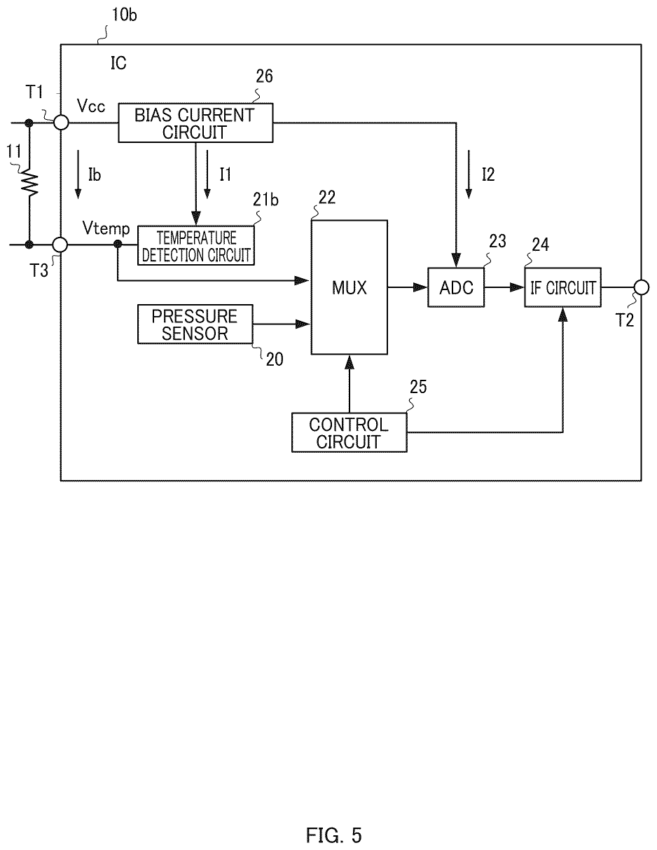

FIG. 5 is a diagram to describe an example of an integrated circuit 10b according to an embodiment of the present disclosure. The integrated circuit 10b is a circuit capable of detecting pressure and temperature. Further, a bias current Ib (described below) can be set by a resistor 11 external to the integrated circuit 10b.

The integrated circuit 10b includes the pressure sensor 20, a temperature detection circuit 21b, the multiplexer (MUX) 22, the ADC 23, the IF circuit 24, the control circuit 25, the bias current circuit 26, and the terminals T1, T2 to a terminal T3. When comparing the integrated circuit 10a in FIG. 1 with the integrated circuit 10b in FIG. 5, the configurations are the same except for the temperature detection circuit 21b and the terminal T3. Accordingly, only the temperature detection circuit 21b and the terminal T3 will be described here.

The terminal T3 is a terminal to which the bias current Ib is supplied from a power supply circuit (not illustrated). Note that the current value of the bias current Ib results in a value corresponding to the resistance value of the resistor 11 connected between the terminal T1 and the terminal T3. Note that the bias current Ib corresponds to a “second bias current”.

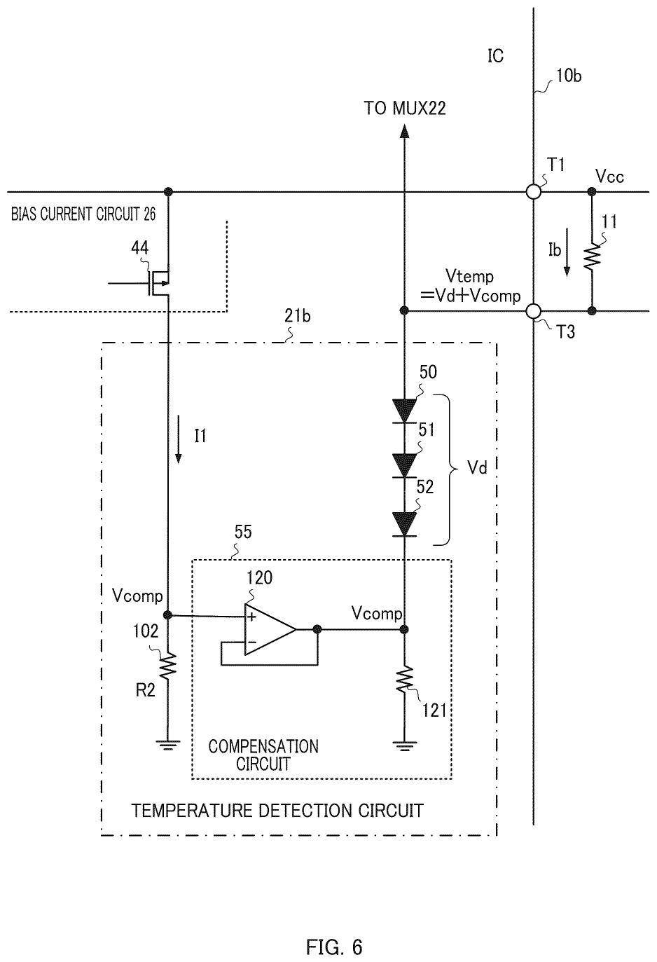

FIG. 6 is a diagram illustrating an example of the signal detection circuit 21b. The temperature detection circuit 21b is a circuit that outputs a voltage Vtemp indicating the environmental temperature Ta to the multiplexer 22 while applying it to the terminal T3, and includes the three diodes 50 to 52, a compensation circuit 55, and a resistor 102. Note that the resistor 11 arranged outside the integrated circuit 10b is connected between the terminal T1 that receives the power supply voltage Vcc and the terminal T3. Thus, the bias current Ib corresponding to the resistance value of the resistor 11 and the power supply voltage Vcc is supplied to the diodes 50 to 52.

The diodes 50 to 52 are connected in series between the terminal T3 and a resistor 121 (described below) of the compensation circuit 55. Note that the diodes 50 to 52 are the same as those three diodes in FIG. 3 except for their connection relationships. Accordingly, detailed description of the diodes 50 to 52 is omitted here.

Similarly to the resistor 101, in response to the bias current I1 being supplied from the bias current circuit 26, the resistor 102 generates a voltage Vcomp given by the following Expression (4):

Vcomp=I1×R2 (4),

where, I1 is the current value of the bias current I1, and R2 is the resistance value of the resistor 102.

The resistance value R2 is determined based on the standard chip temperature of the integrated circuit 10b, for example.

As described above, the bias current I1 of an embodiment of the present disclosure varies according to the reference current I0. Then, the reference current I0 is given, from the above Expression (1), as I0=Vref/R0. Further, the reference voltage Vref of an embodiment of the present disclosure is proportional to the power supply voltage Vcc. Accordingly, the voltage Vcomp in Expression (4) is given by the following Expression (5):

Vcomp∝(R2/R0)×Vcc (5)

The compensation circuit 55 is a circuit that compensates for the voltage Vd such that the temperature detected by the temperature detection circuit 21b reaches the environmental temperature Ta. Specifically, the compensation circuit 55 is a circuit that adds the compensation voltage Vc to the voltage Vd at the diodes 50 to 52, and includes an operational amplifier 120 and the resistor 121.

The operational amplifier 120 has a non-inverting input terminal to which the resistor 102 is connected, and an inverting input terminal to which the output of the operational amplifier 120 is connected. Accordingly, the operational amplifier 120 corresponds to a so-called voltage follower that outputs the voltage Vcomp of the resistor 102.

The resistor 121 is provided between the cathode of the diode 52 and the ground. The output of the operational amplifier 120, which corresponds to the voltage follower, is connected to the diode 52 and the resistor 121. Accordingly, the voltage at the cathode of the diode 52 results in the voltage Vcomp.

Here, the resistor 102 is a polysilicon resistor manufactured to have the same or similar temperature characteristics and variations as those of the resistor 101 in FIG. 3. Accordingly, the voltage Vcomp given in Expression (5) has the same characteristics (here, temperature characteristics, variations, and dependence of power supply voltage Vcc) as the voltage Vc given in Expression (3). As a result, the voltage obtained by adding the voltage Vcomp to the voltage Vd results in the voltage Vtemp.

Accordingly, the temperature detection circuit 21b can output the voltage Vtemp in which the influences of the chip temperature and the power supply voltage Vcc have been suppressed. Thus, for example, by measuring the voltage Vtemp, the environmental temperature Ta can be grasped with high accuracy. The resistor 102 corresponds to the “second resistor”, the resistor 11 corresponds to a “third resistor”, and the resistor 121 corresponds to a “fourth resistor”.

### Summary

The integrated circuits 10a, 10b according to an embodiment of the present disclosure have been described above. For example, the integrated circuit 10b illustrated in FIG. 5 includes a temperature detection circuit 21b illustrated in FIG. 6. The temperature detection circuit 21b includes the compensation circuit 55 configured to apply the voltage Vcomp to the node on the ground side of the three diodes 50 to 52. Accordingly, the temperature detection circuit 21b outputs the voltage Vtemp in which the influence of the chip temperature of the integrated circuit 10b has been suppressed, thereby being able to measure the environmental temperature with high accuracy.

Further, in the integrated circuit 10b, the resistor 11 is connected between the terminal T1 and the terminal T3. Thus, the bias current Ib to be supplied to the diodes 50 to 52 of the temperature detection circuit 21b can be set by the resistor 11.

The compensation circuit 55 also includes: the resistor 121 connected to the cathode of the diode 52; and the voltage follower (here, the operational amplifier 120) configured to apply the voltage Vcomp to the resistor 121. Accordingly, the voltage Vcomp can be set regardless of the current value of the bias current Ib.

Further, for example, the integrated circuit 10a illustrated in FIG. 1 includes the temperature detection circuit 21a illustrated in FIG. 1. In the temperature detection circuit 21a, the resistor 101 configured to generate the voltage Vc is connected to the node on the ground side of the three diodes 50 to 52. Accordingly, the temperature detection circuit 21a outputs the voltage Vt in which the influence of the chip temperature of the integrated circuit 10a has been suppressed, and thus the environmental temperature is measured with high accuracy.

In the integrated circuit 10a, the material of the resistor 100 is the same as the material of the resistor 101, and in the integrated circuit 10b, the material of the resistor 100 is the same as the material of the resistor 102. Accordingly, it is possible to cause the temperature dependence of each of the voltages Vc, Vcomp to be substantially zero.

In the integrated circuit 10a, the variations in the resistor 101 is smaller than the variations in the resistor 100, and in the integrated circuit 10b, the variations in the resistor 102 is smaller than the variations in the resistor 100. Accordingly, each of the voltages Vc, Vcomp can be varied according to the power consumption.

Further, the reference voltage circuit 40 outputs the reference voltage Vref obtained by dividing the power supply voltage Vcc. Accordingly, each of the voltages Vc, Vcomp can be varied according to the power supply voltage Vcc.

The present disclosure is directed to provision of an integrated circuit capable of measuring an environmental temperature with high accuracy.

According to the present disclosure, it is possible to provide an integrated circuit capable of measuring an environmental temperature with high accuracy.

An embodiment of the present disclosure described above is simply to facilitate understanding of the present disclosure and is not in any way to be construed as limiting the present disclosure. The present disclosure may variously be changed or altered without departing from its essential features and encompass equivalents thereof.

What is claimed is:

1. An integrated circuit, comprising:
a bias current circuit including a first resistor, the bias current circuit being configured to generate a first bias current, based on the first resistor and a reference voltage;
a second resistor to which the first bias current is supplied;
n diodes to which a second bias current is supplied, the n diodes being connected in series, the serially-connected diodes having a first node on a power supply side thereof and a second node on a ground side thereof; and
a compensation circuit configured to apply a compensation voltage corresponding to a voltage generated at the second resistor, to the second node,
the n being an integer equal to one or more,
a temperature coefficient of the second resistor and a temperature coefficient of the first resistor being either one of positive or negative.

2. The integrated circuit according to claim 1, further comprising:
a terminal connected to the first node, the terminal being configured to have a third resistor, which is configured to generate the second bias current from a power supply, connected thereto.

3. The integrated circuit according to claim 1, wherein the compensation circuit includes
a fourth resistor provided between the second node and ground, and
a voltage follower configured to apply the compensation voltage to the fourth resistor, based on a voltage generated at the second resistor.

4. An integrated circuit, comprising:
a bias current circuit including a first resistor, the bias current circuit being configured to generate a bias current, based on the first resistor and a reference voltage;
n diodes to which the bias current is supplied, the n diodes being connected in series, the serially-connected diodes having a first node on a power supply side thereof and a second node on a ground side thereof; and
a second resistor connected in series with the n diodes,
the n being an integer equal to one or more,
a temperature coefficient of the second resistor and a temperature coefficient of the first resistor being either one of positive or negative.

5. The integrated circuit according to claim 1, wherein a material of the second resistor is same as a material of the first resistor.

6. The integrated circuit according to claim 5, wherein variations in a resistance value of the second resistor is smaller than variations in a resistance value of the first resistor.

7. The integrated circuit according to claim 6, further comprising:
a reference voltage circuit configured to divide a power supply voltage, to thereby generate the reference voltage.
